(19) United States
(12) Patent Application Publication
(10) Pub. No.: US 2010/0054726 A1
(43) Pub. Date: Mar. 4, 2010

(54) LASER GUIDANCE SYSTEM

(75) Inventors: Hiroshi Tong, Singapore (SG); Kar Hock Jarod Seah, Singapore (SG)

Correspondence Address: HARNESS, DICKEY & PIERCE, P.L.C., P.O. BOX 828, BLOOMFIELD HILLS, MI, 48303, US

(73) Assignee: MEIBAN GROUP LTD., (SG)

(21) Appl. No.: 12/160,315

(22) PCT Filed: Jan. 9, 2007
(86) PCT No.: PCT/SG07/00006

§ 371 Date: Nov. 11, 2008

(30) Foreign Application Priority Data
Jan. 9, 2006 (SG) 200600128-3

(51) Int. Cl. G03B 17/48

(52) U.S. Cl. 396/431

(57) ABSTRACT

A laser guidance system for an image capture device, the system comprising: at least one laser emitting device operatively connected to the image capture device for emitting a laser beam to visually indicate a target area to be captured by the image capture device.

Applicants also submit a Substitute Specification and a Red-Lined Specification.

The Red-Lined Specification shows minor amendments to some of the section headings and has been reformatted to US patent practices. No new matter has been added.

The Substitute Specification incorporates the changes made in the Red-Lined specification and, except for the section heading changes and reformatting, is identical to the Chapter II specification. No new matter has been added.

### FIELD

The present disclosure relates to a laser guidance system for an image capture device.

### BACKGROUND

Image capture devices such as digital still cameras or digital video cameras require a view finder or a display screen to visually aid a user in directing and pointing the image capture device to capture an image. The view finder provides a reference frame for the capture of an image. However, this significantly limits the use of the image capture device. The user must look into the view finder in order to capture an image of a subject at a correct position and angle. Similarly, when using an image capture device with a display screen, such as a LCD screen, the display screen must be visible to the user to capture an image in a correct position and angle.

The user is strictly limited in his ability to capture an image from extreme angles, creative angles and constrained spaces. Also, for users with certain physical limitations or the elderly, positioning of image capture devices is difficult as they need to look at the view finder or the display screen, which may be a visually small area.

Another image capture device is one that has a rotatable view finder, a rotatable lens or a rotatable display screen. However, these image capture devices require additional mechanisms and are not easy to operate. The operation of the view finder, rotatable lens or display screen dramatically reduces the speed in capturing an image. This is not desirable when capturing candid shots and spontaneous events.

In addition, such image capture devices cannot be operated properly when attached to various locations, such as a user's body, helmet or equipment, this will render the image capture device useless as the user will not be able to view his image through the view finder or display screen and will not know if he has captured the subject he had in mind. For example, such image capture devices are not suitable for users in environments, such as a coal mine environment, where it is inconvenient to hold the image capture device while working.

Other prior art discloses methods of measuring distances, or to achieve remote control using lasers, which are not applicable to solve problems of the present invention. US2005/0041112A1 discloses a digital camera and a remote control and requires a remote control, viewfinder or display screen to capture an image.

Therefore, there is a desire for an improved image capture device to address at least some of the abovementioned problems.

### SUMMARY

In a first preferred aspect, there is provided a laser guidance system for an image capture device, the system comprising:

at least one laser emitting device operatively connected to the image capture device for emitting a laser beam to visually indicate a target area to be captured by the image capture device.

A control module may be provided to stop emission of the laser beam when the image is captured such that the laser beam is not visible in the captured image.

The control module may control the laser emitting device according to a predetermined program to emit the laser beam at various blinking speeds or remain constantly on.

The control module may control the laser emitting device to emit the laser beam based on various shooting conditions or to indicate different levels of zoom.

A power control module may be provided to control the intensity of the laser beam.

A post-processing module may be provided to filter visual evidence of the laser beam from the captured image such that the laser beam is not visible in the captured image.

A modulating module may be provided to modulate the frequency of the laser beam such that the laser beam is not visible in the captured image.

The laser beam may be directed to the centre of the target area

The laser beam may be directed to a plurality of points at the perimeter of the target area.

In a second aspect, there is provided an image capture device comprising:

a laser guidance system having at least one laser emitting device operatively connected to the image capture device for emitting a laser beam to visually indicate a target area to be captured by the image capture device.

In a third aspect, there is provided a mounting device to be mounted to a hot-shoe of an image capture device, the mounting device comprising:

a laser guidance system having at least one laser emitting device operatively connected to the image capture device for emitting a laser beam to visually indicate a target area to be captured by the image capture device.

The mounting device further may comprise a hot-shoe to operatively connect with an external flash device or another hot-shoe attachment.

### DRAWINGS

An example of the invention will now be described with reference to the accompanying drawings, in which:

FIG. 1 is a block diagram of a laser guidance system for an image capture device in accordance with a preferred embodiment of the present invention;

FIG. 2 is a schematic diagram illustrating a subject marked with a crosshair laser and L-shaped lasers at two peripheral corners;

FIG. 3 is a system diagram of the laser guidance system of FIG. 1 during operation;

FIG. 4 is a perspective view of an image captured device with an integrated laser guidance system;

FIG. 5 is an exploded perspective view of a mounting member with a laser guidance system to be mounted to the hot-shoe of an image capture device; and

FIG. 6 is a perspective view of a mounting member with a laser guidance system mounted to the hot-shoe of an image capture device.

### DETAILED DESCRIPTION

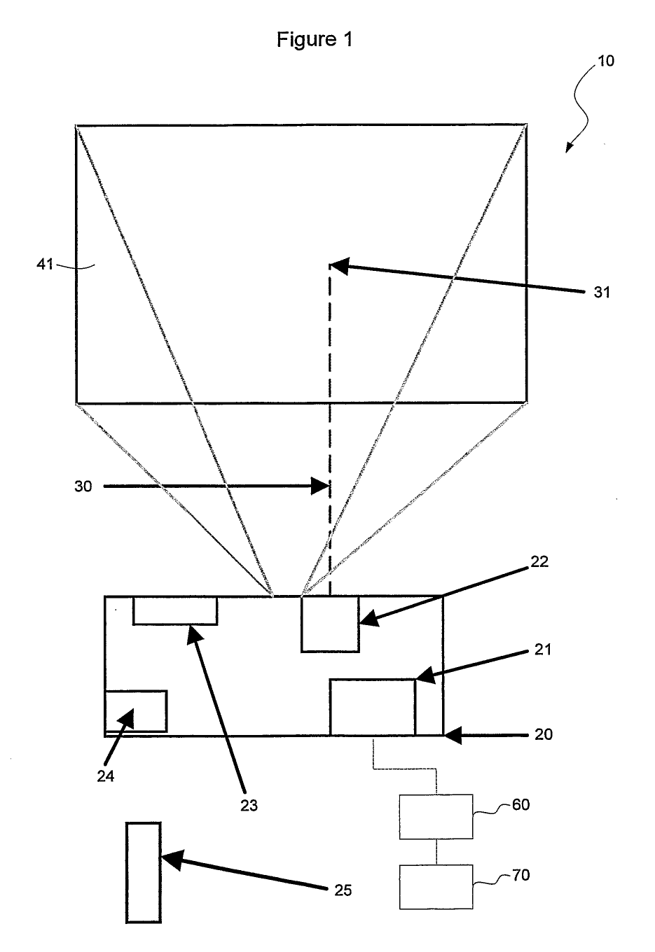

Referring to FIG. 1, a laser guidance system 10 for an image capture device 20 is provided. The system 10 comprises: at least one laser emitting device 22 operatively connected to the image capture device 20. The laser emitting device 22 emits a laser beam 30 to visually indicate a target area 41 to be captured by the image capture device 20. The laser emitting device 22 generates one or more laser beams 30 onto the target 41 to provide a reference point for capturing an image by the image capture device 20.

Image Capture Device

The image capture device 20 is hand held or placed anywhere that has clear and unobstructed view of the target 41. This includes: on a tripod, mounted on a headgear, handlebars of bikes, boards, or jackets. The image capture device 20 is equipped with a digital or optical zoom, or may operate normally. The image capture device 20 can be incorporated as a USB storage device for storing captured images and which can be easily used for transferring stored images to a computer.

Preferably, the image capture device 20 is a still camera or a video camera, and operates in either digital or analog mode. For example, the image capture device 20 may operate in digital mode if it uses a digital processor (CCD/CMOS) and one or more memory storage devices 24 for storing captured images. The image capture device 20 may operate in analog mode using mechanical means and photographic film, such as a celluloid film.

Laser Emitting Device

Laser emitting device 22 generates a laser beam 30 to mark the reference point of the center of the field when the shutter release button is partially depressed at a first stage of a two stage process. A visible laser beam 30 is emitted from the laser emitting device 22 and projected onto the target 41 as a light spot 31 to reference the center or edge of the field of capture. The light spot 31 is visible on the target 41 for the user.

One or more visible light spots 31 on a target 41 or area are created to provide a reference point for capturing an image by the image capture device 20. The laser beam 30 is of certain specific wavelength and power sufficient such that a visible light spot 31 is created in any type of lighting condition or environment. For example, the laser beam 30 is a class 2 laser beam with a wavelength between 630-680 nm and with an output power up to or about 1 mW. Light spots 31 positively indicate the target 41 and/or area that is to be captured or provides a frame of reference to a user for capturing an image. Light spots 31 are provided in any shape including a crosshair, L-shape, box, circle, line, figures and variations of patterns. Light spots 31 are provided in several shapes using additional attachments to laser emitting device 22.

The laser emitting device 22 is programmable to emit the laser beam 30 at various blinking speeds or remain constantly on, based on different shooting conditions, for example, blink at different interface to indicate different levels of zoom, providing a reference to the user. If zooming is performed, the angle of the laser emission moves inwards towards the centre to indicate that the field of capture is tightened.

Two or more lenses are used to perform zooming. An additional laser emitting device may be added to provide edge guides as well to provide a frame of reference. However, a single laser emitting device may used where optics are used to split the laser beam 30.

Marking the target 41 with the laser 30 provides a reference for the field of capture eliminating the need to preview the target 41 through a view finder or an LCD screen of the image capture device 20. Also, the image capture device 20 is effective in different locations where the view finder or LCD display is not accessible to the user since the optical laser marking allows the user to gauge the field of capture that will be captured. The system 10 enables true point-and-shoot functionality, especially for low light level environments such as evening and night. This simplifies the image capture process as well as increases the usage, convenience and applications of the image capture device 20 in situations where the user cannot directly view the view finder or the LCD screen, or where it is so dark that the view finder is rendered useless.

Controller

A controller 23 is provided for controlling the output of the laser emitting device 22. All functional components of the image capture device 20 are interfaced with the controller 23.

In one embodiment, the controller 23 is an electronic circuit controlling the laser emitting device 22. The controller 23 activates the laser emitting device 22 in one or more operating modes. For example, the controller 23 activates the laser emitting device 22 on and off, blink or with a timer when a timer button is pressed. The laser beam 30 is deactivated during image capture to avoid having the light spots 31 being captured in the image. When the controller 23 detects the shutter release button is pressed, the laser emitting device 22 temporarily deactivates emission of the laser beam 30. The controller 23 is also able to keep the laser emitting device 22 activated during image capture. The controller 23 also controls intensity of laser emitting device 22 via a power controller 21. The controller 23 also has a memory 24 to store captured images. Captured images are downloadable from the memory 24 to another device, such as a desktop computer, notebook computer or mobile phone.

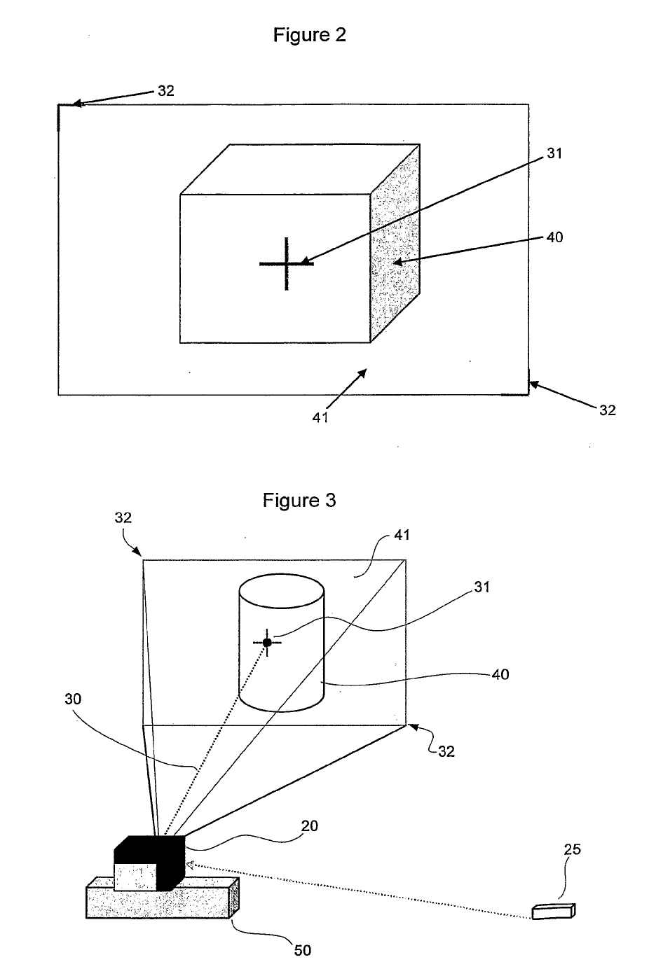

Referring to FIG. 2, a target object 40 in a target area 41 is marked with a crosshair laser point 31. The background of the target area 41 is marked with L-shaped laser indications 32 at two peripheral corners. The crosshair laser point 31 provides a visual indication of the centre of an image to be captured, and the L-shaped laser indications 32 indicate the top left and bottom right corners of the image to be captured. A combination of one or more various shaped laser beam(s) 30 may be used to provide a guide for capturing an image with the image capture device 20.

Referring to FIG. 3, the image capture device 20 is placed on an object 50. In one embodiment, a remote control 25 is used to operate the image capture device 20. The remote control 25 is used to remotely operate image capture device 20 via a cable or wirelessly. Since the field of capture is visually indicated because of the laser beams 30, the user simply uses the remote control 25 to cause images to be captured without having to look through the view finder or be in close proximity with the image capture device 20.

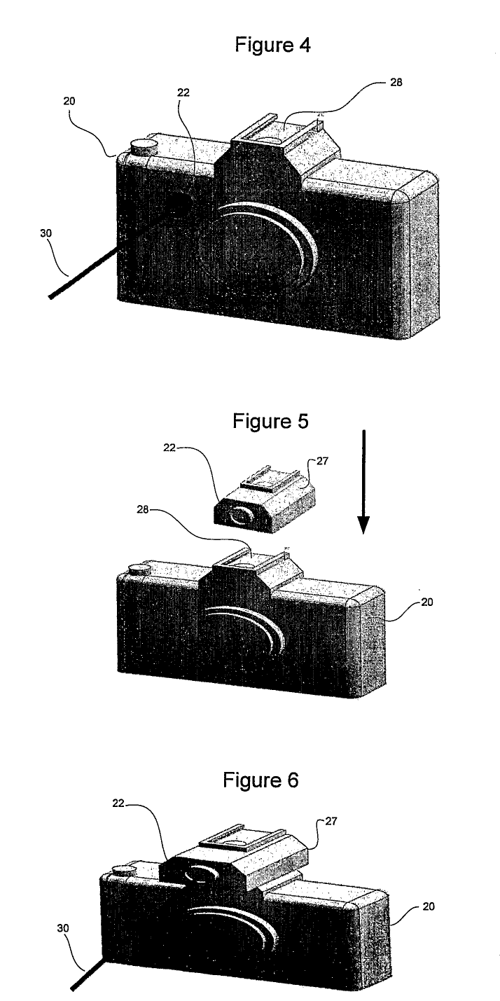

Referring to FIG. 4, in one embodiment, the laser guidance system 10 is integrated with the image capture device 10. Typically, the image capture device 10 has a hot-shoe 28 to receive an external flash device or another hot-shoe attachment. The hot-shoe 28 is of any standard such as, for example, Nikon, Canon, Pentax or Minolta.

Referring to FIGS. 5 and 6, in another embodiment, the laser guidance system 10 is provided on a mounting member 27 which is coupled to the image capture device 20 via the hot-shoe 28. The laser emitting device 22 is provided on the mounting member 27 and is controlled by the controller 23 via electrical signals communicated between the image capture device 20 and the mounting member 27 via the hot-shoe 28. A suitable “handshake” or “interface protocol” is used for communication.

The mounting member 27 also has a hot shoe 29 to receive an external flash device or another hot-shoe attachment which is controlled by the controller 23 via electrical signals communicated from the image capture device 20 and the mounting member 27 to the external flash or another hot shoe attachment via the hot-shoes 28 and 29.

Rather than temporarily deactivate the laser emitting device 22 during image capture, the system 10 comprises a post-processing module 60 to filter visual evidence of the laser beam 30 from the captured image such that the laser beam 30 is not visible in the captured image. Alternatively, the system 10 comprises a modulating module 70 to modulate the frequency of the laser beam 30 such that the laser beam 30 is not visible in the captured image. The modulating module 70 controls the power, intensity and wavelength of the laser beam 30.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

1. A laser guidance system for an image capture device, the system comprising:
at least one laser emitting device operatively connected to the image capture device for emitting a laser beam to visually indicate a target area to be captured by the image capture device, and
a post-processing module to filter visual evidence of the laser beam from the captured image such that the laser beam is not visible in the captured image.

2. The system according to claim 1, further comprising a control module to stop emission of the laser beam when the image is captured such that the laser beam is not visible in the captured image.

3. The system according to claim 2, wherein the control module controls the laser emitting device according to a predetermined program to emit the laser beam at various blinking speeds or remain constantly on.

4. The system according to claim 2, wherein the control module controls the laser emitting device to emit the laser beam based on various shooting conditions or to indicate different levels of zoom.

5. The system according to claim 1, further comprising a power control module to control the intensity of the laser beam.

6. (canceled)

7. The system according to claim 1, further comprising a modulating module to modulate the frequency of the laser beam such that the laser beam is not visible in the captured image.

8. The system according to claim 1, wherein the laser beam is directed to the centre of the target area

9. The system according to claim 1, wherein the laser beam is directed to a plurality of points at the perimeter of the target area.

10. An image capture device comprising:
a laser guidance system having at least one laser emitting device operatively connected to the image capture device for emitting a laser beam to visually indicate a target area to be captured by the image capture device and further comprising a post-processing module to filter visual evidence of the laser beam from the captured image such that the laser beam is not visible in the captured image.

11. A mounting device to be mounted to a hot-shoe of an image capture device, the mounting device comprising:
a laser guidance system having at least one laser emitting device operatively connected to the image capture device for emitting a laser beam to visually indicate a target area to be captured by the image capture device.

12. The mounting device according to claim 11, wherein the mounting device further comprises a hot-shoe to operatively connect with an external flash device or another hot-shoe attachment.
